(19) United States
(12) Patent Application Publication
(10) Pub. No.: US 2022/0393217 A1
(43) Pub. Date: Dec. 8, 2022

(54) FUEL CELL STRUCTURE

(71) Applicant: DENSO CORPORATION, Kariya-city (JP)

(72) Inventors: Junya TANAKA, Kariya-city (JP); Shinichi SUGIHARA, Kariya-city (JP); Ryosuke SAKO, Kariya-city (JP); Miyu KOJIMA, Kariya-city (JP)

(21) Appl. No.: 17/824,965

(22) Filed: May 26, 2022

(30) Foreign Application Priority Data
Jun. 3, 2021 (JP) 2021-093547

(51) Int. Cl. H01M 8/248; H01M 8/2475

(52) U.S. Cl. CPC H01M 8/248; H01M 8/2475

(57) ABSTRACT

A fuel cell structure includes; a cell stack in which a plurality of cells is stacked; a fastening mechanism configured to fasten the cell stack in a compressed state from both sides in a stacking direction of the plurality of cells; and a load receiving mechanism configured to receive a linear expansion load from the cell stack in a compression release direction. The linear expansion load is caused by a decrease in compressive load by the fastening mechanism when a temperature of the cell stack is raised.

### CROSS REFERENCE TO RELATED APPLICATION

This application is based on Japanese Patent Application No, 2021-093547 filed on Jun. 3, 2021 the disclosure of which is incorporated herein by reference.

### TECHNICAL FIELD

The present disclosure relates to a fuel cell structure.

### BACKGROUND

A fuel cell has a cell stack in which EA cells are stacked with each other. The cell stack is held by a fastening structure such as bolt, nut, and compression spring.

### SUMMARY

According to an aspect of the present disclosure, a fuel cell structure includes: a cell stack formed by stacking a plurality of cells; a fastening mechanism configured to fasten the cell stack in a compressed state from both sides in a stacking direction of the plurality of cells;

and a load receiving mechanism configured to receive a load in a compression release direction from the cell stack fastened by the fastening mechanism. The load receiving mechanism is configured to receive a linear expansion load in the compression release direction. The linear expansion load is caused by a decrease in the compressive load by the fastening mechanism when the temperature of the cell stack is raised.

### BRIEF DESCRIPTION OF DRAWING

FIG. 1 is a perspective view illustrating a fuel cell structure according to a first embodiment as viewed from an upper side.

FIG. 2 is a side view of the fuel cell structure.

FIG. 3 is a cross-sectional view of a cell stack of the fuel cell structure.

FIG. 4 is a cross-sectional view taken along a line IV-IV of FIG. 2.

FIG. 5 is a cross-sectional view for explaining an assembly of the fuel cell structure,

FIG. 6 is a cross-sectional view for explaining an operation by a load receiving mechanism of the fuel cell structure.

FIG. 7 is a cross-sectional view of a fuel cell structure according to a second embodiment, corresponding to FIG. 4.

FIG. 8 is a cross-sectional view of a fuel cell structure according to a third embodiment, corresponding to FIG. 4,

FIG. 9 is a cross-sectional view of a fuel cell structure according to a fourth embodiment, corresponding to FIG. 4.

FIG. 10 is a cross-sectional view of a fuel cell structure according to a fifth embodiment, corresponding to FIG. 4.

FIG. 11 is a cross-sectional view of a fuel cell structure according to a sixth embodiment, corresponding to FIG. 4.

FIG. 12 is a side view of a fuel cell structure according to a seventh embodiment, corresponding to FIG. 2.

FIG. 13 is a cross-sectional view taken along a line XIII-XIII of FIG. 12.

### DESCRIPTION OF EMBODIMENTS

To begin with, examples of relevant techniques will be described.

A solid oxide fuel cell is one of fuel cell structures, A fuel cell has a cell stack in which a plurality of MEA cells are stacked with each other, and a fastening structure for fastening the cell stack in a state compressed by bolts, nuts, and compression springs. In the fastening structure, the bolt is engaged with the nut with the compression spring inserted in the shaft portion. As a result, the compression spring made of ceramic is configured to receive all of the load caused by fastening the bolt and the nut at the time of assembly.

When the fuel cell is used in a high temperature environment such as over 700° C., the temperature of the cell stack rises, and a linear expansion difference is generated relative to the bolt. In this case, the load applied to the cell stack at the time of assembly is reduced, which is so-called “load loss.” If the load loss is generated, the compressive load applied to the cell stack is reduced, and the current collecting property and the gas sealing property are deteriorated.

In this kind of fuel cell structure, it is desirable that a compressive load is applied to the cell stack in order to restrict misalignment between members of the cell stack during transportation at room temperature. It is desirable that a compressive load is always applied to the cell stack under conditions from a room temperature to high temperature (operating temperature). In case where the cell stack is compressed by a spring member, the spring member further receives a linear expansion load generated in a compression release direction when the temperature of the cell stack rises. In this case, since the spring member bears both the function of compressing the cell stack and the function of receiving the linear expansion load, the load to be received by the spring member is large, so that the spring member is made larger or the number of spring members is increased. As a result, the fuel cell structure needs to be large. Further, even if a ceramic compression spring having a small decrease in strength under high temperature conditions is used, it is difficult to fundamentally solve such an issue.

The present disclosure provides a small-size fuel cell structure capable of suppressing a load loss when a temperature of a cell stack is raised.

According to the present disclosure, a fuel cell structure includes: a cell stack formed by stacking a plurality of cells: a fastening mechanism configured to fasten the cell stack in a compressed state from both sides in a stacking direction of the plurality of cells: and a load receiving mechanism configured to receive a load in a compression release direction from the cell stack fastened by the fastening mechanism. The load receiving mechanism is configured to receive a linear expansion load in the compression release direction. The linear expansion load is caused by a decrease in the compressive load by the fastening mechanism when the temperature of the cell stack is raised.

In the fuel cell structure, the cell stack formed by stacking the cells is fastened in a state of being compressed from both sides by the fastening mechanism at the time of assembly. Therefore, in the assembled state of the cell stack, the cell stack receives a compressive load from the fastening mechanism, while the fastening mechanism receives a load from the cell stack in the compression release direction, which is an opposite direction of the compression direction.

Since the cell stack is usually used under high temperature conditions, the cell stack expands and deforms when the temperature rises. At this time, when the linear expansion difference between the cell stack and the fastening mechanism is large, the compressive load received by the cell stack from the fastening mechanism may decrease. When the compressive load is reduced, the current collecting property and the gas sealing property of the cell stack are lowered.

To solve such an issue, the cell stack may be compressed by the spring member and the linear expansion load generated in the compression release direction is received by the spring member when the temperature of the cell stack is raised. In this case, however, the load to be received by the spring member is large. It is necessary to increase the size or number of spring members, so that the fuel cell structure becomes large.

Therefore, the load receiving mechanism is provided separately from the fastening mechanism in order to receive the load in the compression release direction from the cell stack compressed by the fastening mechanism. The load receiving mechanism has a function of receiving a linear expansion load in the compression release direction caused by a decrease in the compression load of the fastening mechanism when the temperature of the cell stack is raised. That is, the linear expansion load, which is an increase in load when the temperature of the cell stack is raised, is received by the load receiving mechanism provided separately from the fastening mechanism for fastening the cell stack in the compressed state.

As a result, the load receiving mechanism can restrict the load loss when the temperature of the cell stack rises, and the cell stack can be maintained in a desired compressed state. Thus, it is possible to suppress deterioration in the current collecting property and gas sealing property of the cell stack. Further, the load receiving mechanism receives the linear expansion load generated in the compression release direction when the temperature of the cell stack rises. Therefore, even if the spring member is used for the fastening mechanism or the load receiving mechanism, the load undertaken by the spring member can be kept low as a linear expansion load which is an increase when the temperature of the cell stack rises. Thus, the number or size of spring members can be reduced. As a result, it becomes possible to restrict the fuel cell structure from becoming large.

Accordingly, it is possible to provide a small-size fuel cell structure capable of suppressing a load loss when the temperature of the cell stack rises.

The reference numerals in embodiments indicate a correspondence with the specific means described in the embodiments, and the technical scope of the present disclosure is not limited by the reference numerals.

Hereinafter, embodiments will be described with reference to the drawings.

In the drawings, unless otherwise specified, a first direction X represents a lateral direction of a cell stack, which has a flat shape, of a fuel cell structure. A second direction Y is perpendicular to the first direction X in the cell stack. A third direction Z is a stacking direction of plural cells in the cell stack.

### First Embodiment

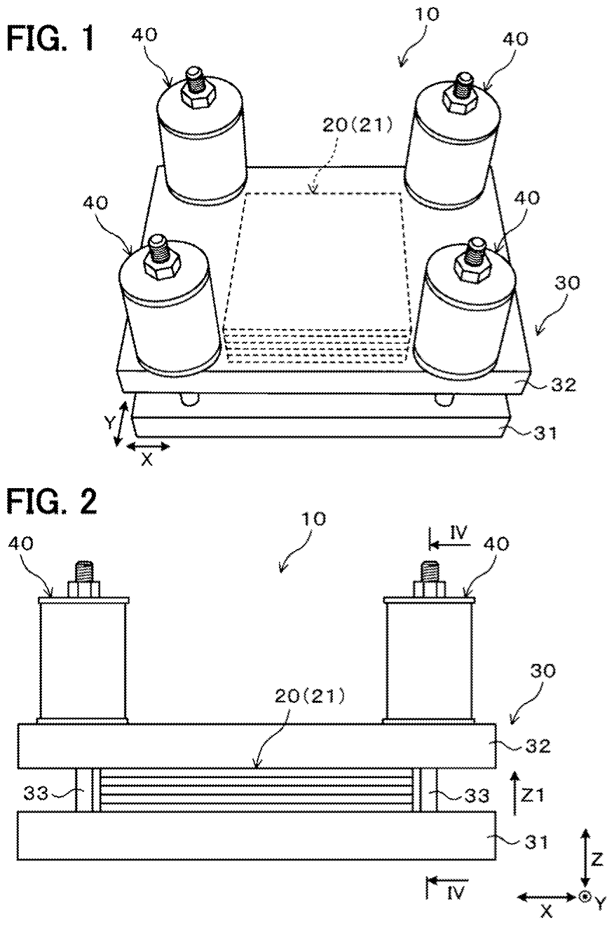

A fuel cell structure 10 of a first embodiment shown in FIGS. 1 and 2 is a solid oxide fuel cell (SOFC), and is used under high temperature conditions. For example, the fuel cell structure 10 is operated under condition where the environment temperature exceeds 700° C.,

The fuel cell structure 10 generally includes a cell stack 20, a fastening mechanism 30, and a load receiving mechanism 40.

The cell stack 20 is a flat plate-shaped stacked body in which plural flat plate-shaped cells 21 having the same shape are stacked in the third direction Z (see FIG. 2). The cell 21 is a basic member for generating electricity. The cell 21 has a substantially rectangular shape in a plan view in the third direction Z.

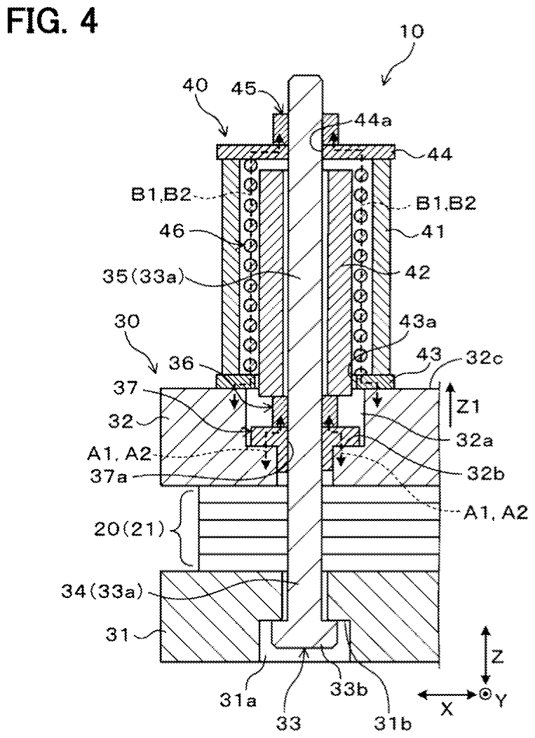

The fastening mechanism 30 fastens the cell stack 20 in a compressed state from both sides in the third direction Z (see FIG. 2) solely. The fastening mechanism 30 is configured to receive a load in a compression release direction Z1 (see FIG. 2) in which the cell stack 20 is decompressed at the time of fastening. The compression release direction Z1 may be referred to as a linear expansion direction. The fastening mechanism 30 includes a bottom plate 31 provided so as to face the lower surface of the cell stack 20, an upper plate 32 provided so as to face the upper surface of the cell stack 20, a bolt member 33, a nut member 36 and a collar 37 (see FIG. 4). The fastening mechanism 30 does not have a spring member as a component.

The cell stack 20 is interposed between the bottom plate 31 and the upper plate 32 to be held from both sides in the third direction. Z. Each of the bottom plate 31 and the upper plate 32 is a flat metal member having a size that covers the cell stack 20. The bolt member 33 applies an axial force, for compressing the cell stack 20, to the bottom plate 31 and the upper plate 32, and is a shaft member extending in the third direction Z as the axial direction.

The load receiving mechanism 40 receives the load in the compression release direction Z1 from the cell stack 20 compressed by the fastening mechanism 30. The load receiving mechanism 40 is configured to receive a linear expansion load in the compression release direction Z1, which is caused by a decrease in the compressive load by the fastening mechanism 30 when the temperature of the cell stack 20 is raised. The linear expansion load at this time may be caused by a so-called “load loss” phenomenon that the load applied to the cell stack 20 at the time of assembly is reduced by the linear expansion difference between the cell stack 20 and the fastening mechanism 30.

In this embodiment, four load receiving mechanisms 40 are provided. The four load receiving mechanisms 40 are arranged so as to surround the cell stack 20 on the outer peripheral surface of the upper plate 32 in a plan view (see FIG. 1) of the fuel cell structure 10 in the third direction Z.

The number and arrangement of the load receiving mechanisms 40 are not limited to those shown in FIG. 1. It is preferable to arrange the load receiving mechanisms 40 in an appropriate number and at an appropriate position so as to receive the linear expansion load generated in the compression release direction Z1 in a well-balanced manner.

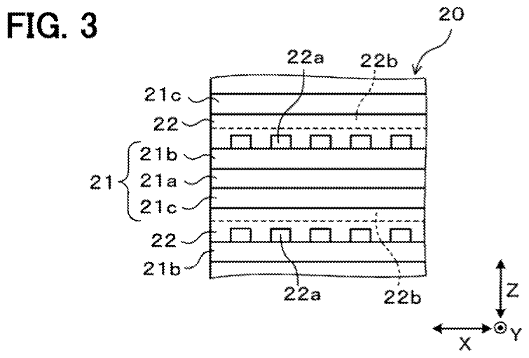

As shown in FIG. 3, each of the cells 21 of the cell stack 20 is generally referred to as “single cell” and “fuel cell”. Each cell 21 has an electrolyte 21a, a fuel electrode (anode) 21b and an air electrode (cathode) 21c. The electrolyte 21a is arranged between the fuel electrode 21b and the air electrode 21c in the third direction Z. Each cell 21 is typically an ASC (anode support cell) in which the electrolyte 21a, the fuel electrode 21b, and the air electrode 21c are all made of a ceramic base, or an MSC (metal support cell) in which a part of the fuel electrode 21b is made of metal.

A separator 22 is arranged on both sides of each cell 21 in the third direction Z. That is, the separator 22 is interposed between the two cells 21. The cell stack 20 as a stacked body is formed by stacking the cells 21 with the separator 22 interposed therebetween.

Each separator 22 has first passages 22a formed adjacent to the fuel electrode 21b and second passages 22b formed adjacent to the air electrode 21c. Hydrogen as a fuel gas flows through each of the first passages 22a parallel to each other and extended in the second direction Y. Air as an oxidizing gas flows through each of the second passages 22b parallel with each other and extended in the first direction X. The extending direction of the first passage 22a and the extending direction of the second passage 22b are not particularly limited, and the extending direction may be appropriately changed as necessary. For example, the first passage 22a may extend in the first direction X. The first passage 22a may extend in a direction different from the first direction X and the second direction Y. The second passage 22b may extend in the second direction Y. The second passage 22b may extend in a direction different from the first direction X and the second direction Y. Further, it is preferable that a current collector (not shown) is provided between the cell 21 and the separator 22 to improve the current collection efficiency.

Next, a specific configuration of the fastening mechanism 3 will be described.

As shown in FIG. 4, the bolt member 33 has a cylindrical shaft portion 33a and a head portion 33b provided at one end of the shaft portion 33a. The head portion 33b has an outer diameter larger than the outer diameter of the shaft portion 33a A male thread is formed on the outer circumference of the shaft portion 33a. The shaft portion 33a has a first shaft portion 34 adjacent to the head portion 33b and a second shaft portion 35 which is a tip end side of the first shaft portion 34,

The shaft portion 33a extends in the third direction Z so as to penetrate both the through hole 31a of the bottom plate 31 and the through hole 32a of the upper plate 32. The head portion 33b of the bolt member 33 is restricted from moving upward with respect to the bottom plate 31 by being caught by a stepped portion 31b formed inside the through hole 31a of the bottom plate 31.

The nut member 36 is an engaging portion provided on the bolt member 33 in order to compress the cell stack 20 in the third direction Z by utilizing the axial force of the bolt member 33. The nut member 36 is an engaging member separate from the bolt member 33, and is attached to the bolt member 33 by engaging with the first shaft portion 34 of the bolt member 33.

The nut member 36 has a through hole in which a female thread is formed on the inner surface. The nut member 36 and the bolt member 33 compress the cell stack 20 in the third direction Z when the nut member 36 is engaged with the first shaft portion 34 of the bolt member 33. The nut member 36 is an engaging portion provided on the bolt member 33 by threading (engaging) with the bolt member 33.

At the time of assembling the fastening mechanism 30, the shaft portion 33a of the bolt member 33 is inserted into the through hole 31a of the bottom plate 31 and the through hole 32a of the upper plate 32. The nut member 36 inserted in the through hole 32a of the upper plate 32 is engaged with the first shaft portion 34. As a result, the fastening mechanism 30 is assembled in a state where the bottom plate 31 and the upper plate 32 are compressed so as to approach each other in the third direction Z.

In the assembled state of the fastening mechanism 30, a compressive load for compressing the cells 21 from both sides in the third direction Z is applied to the cell stack 20 via the bottom plate 31 and the upper plate 32. This compression load can also be referred to as a fastening load for fastening the cell stack 20. At this time, the nut member 36 applies a load in the compression direction to the cell stack 20, while receiving a load from the cell stack 20 in the compression release direction Z1 which is opposite to the compression direction.

According to the fastening mechanism 30 having the above configuration, by compressing the cell stack 20, the contact property between the cell 21 and the separator 22 can be improved to improve the current collecting efficiency, and the scalability of the first passage 22a and the second passage 22b of the separator 22 can be improved to improve the gas sealability.

It is preferable to use the collar 37 that engages with the stepped portion 32b formed inside the through hole 32a, for positioning the shaft portion 33a of the bolt member 33 in the through hole 32a of the upper plate 32. At this time, the bolt member 33 is engaged with the nut member 36 in a state where the first shaft portion 34 of the bolt member 33 is inserted into the through hole 37a of the collar 37. The collar 37 is preferably made of an electrical insulating material (for example, alumina) in order to ensure the electrical insulation at the both electrodes of the cell stack 20.

At this time, the first shaft portion 34 represents the shaft portion 33a of the bolt member 33 between the head portion 33b and the nut member 36. The second shaft portion 35 is the tip end side of the shaft portion 33a of the bolt member 33, and is located between the nut member 36 and a nut member 45 described later. In the present embodiment, the first shaft portion 34 of the bolt member 33 is a component of the fastening mechanism 30, while the second shaft portion 35 is a component of the load receiving mechanism 40.

Next, a specific configuration of the load receiving mechanism 40 will be described.

As shown in FIG. 4, the load receiving mechanism 40 includes the second shaft portion 35 of the bolt member 33, an outer collar 41, an inner collar 42, a washer 43, a holding plate 44, the nut member 45, and a spring member 46 as an elastic element.

Both the outer collar 41 and the inner collar 42 are formed in a cylindrical shape. The inner collar 42 having a diameter smaller than that of the outer collar 41 is housed in the outer collar 41. At this time, a space between the outer collar 41 and the inner collar 42 becomes a storage space for storing the spring member 46. The shaft portion 33a of the bolt member 33 passes through the inner collar 42. The lower part of the inner collar 42 is inserted into the through hole 43a of the washer 43.

The spring member 46 is a compression coil spring that is elastically deformably interposed between the cell stack 20 and the nut member 45 in the third direction Z When the spring member 46 is arranged in the space between the outer collar 41 and the inner collar 42, the upper end of the spring member 46 abuts on the holding plate 44, and the lower end of the spring member 46 abuts on the washer 43 in contact with the upper surface 32c of the upper plate 32. The material of the spring member 46 is not particularly limited, but in order to keep the cost low, it is preferable to form the spring member 46 by using a wire rod made of a metal material. Further, it is preferable to use ceramics such as silicon nitride as the material of the spring member 46 for the purpose of restricting the load loss during long-term use at high temperature.

The second shaft portion 35 of the bolt member 33 is engaged with the nut member 45 in a state of being inserted into the through hole 44a of the holding plate 44. The nut member 45 is an engaging portion provided on the bolt member 33 in order to compress the cell stack 20 in the third direction Z by utilizing the axial force of the bolt member 33. The nut member 45 is an engaging member that is separate from the bolt member 33, and is attached to the bolt member 33 by being threaded with the second shaft portion 35 of the bolt member 33.

Similarly to the nut member 36, the nut member 45 has a through hole in which a female thread is formed on the inner surface. When the nut member 36 is used as a first engaging portion, the nut member 45 is configured as a second engaging portion that engages with the second shaft portion 35 of the bolt member 33. The nut member 45 is engaged with the second shaft portion 35 of the bolt member 33 while the nut member 36 is engaged with the first shaft portion 34 of the bolt member 33. The nut member 45 functions to pressurize the cell stack 20 in cooperation with the bolt member 33 when being threaded with the second shaft portion 35 of the bolt member 33. The nut member 45 is an engaging portion provided on the bolt member 33 by threading (engaging) with the bolt member 33.

The load receiving mechanism 40 is assembled to the upper portion of the upper plate 32 by threading the nut member 45 into the second shaft portion 35 of the bolt member 33 against the elastic urging force of the spring member 46. At this time, the load receiving mechanism 40 is configured to apply an elastic urging force by the spring member 46 to the upper plate 32 of the fastening mechanism 30. Therefore, the load receiving mechanism 40 applies a load in the compression direction to the cell stack 20 independently of the compression by the fastening mechanism 30.

That is, as schematically shown in FIG. 4, according to the fastening mechanism 30, when the nut member 36 is threaded with the first shaft portion 34 of the bolt member 33, a load in the compression direction is input from the nut member 36 through the stepped portion 32b of the upper plate 32 to the cell stack 20 in a load input path A1. On the other hand, the nut member 36 receives a load from the cell stack 20 in the direction opposite to the compression direction through a load receiving path A2 opposite to the load input path A1.

According to the load receiving mechanism 40, in a state where the nut member 45 is threaded with the second shaft portion 35 of the bolt member 33, a load in the compression direction is input to the cell stack 20 from the nut member 45 through the upper surface 32c of the upper plate 32 in a load input path B1 independent of the load input path A1 of the fastening mechanism 30. On the other hand, the nut member 45 receives a load from the cell stack 20 in the direction opposite to the compression direction through a load receiving path B2 opposite to the load input path B1.

The load input path A1 of the fastening mechanism 30 is defined from the nut member 36 to the upper plate 32 via the collar 37. The load receiving path A2 of the fastening mechanism 30 is in the reverse direction of the load input path A1, and is defined from the upper plate 32 to the nut member 36 via the collar 37. The load input path B1 of the load receiving mechanism 40 is defined from the nut member 45 to the upper plate 32 via the holding plate 44, the spring member 46 and the washer 43. The load receiving path B2 of the load receiving mechanism 40 is in the reverse direction of the load input path B1 and is defined from the upper plate 32 to the nut member 45 via the washer 43, the spring member 46, and the holding plate 44. In FIG. 4, for convenience, the two paths A1 and A2 are indicated by one arrow line, and the two paths B1 and B2 are indicated by one arrow line.

At this time, the load input path A1 and the load input path B1 are parallel to enable independent load transmission, and the load receiving path A2 and the load receiving path B2 are parallel to enable independent load transmission.

In FIG. 4, the four paths A1, A2, B1, and B2 are all represented by schematic lines, and these are merely schematic. In reality, the four paths A1, A2, B1 and B2 are formed over the entire circumference of the shaft portion 33a of the bolt member 33.

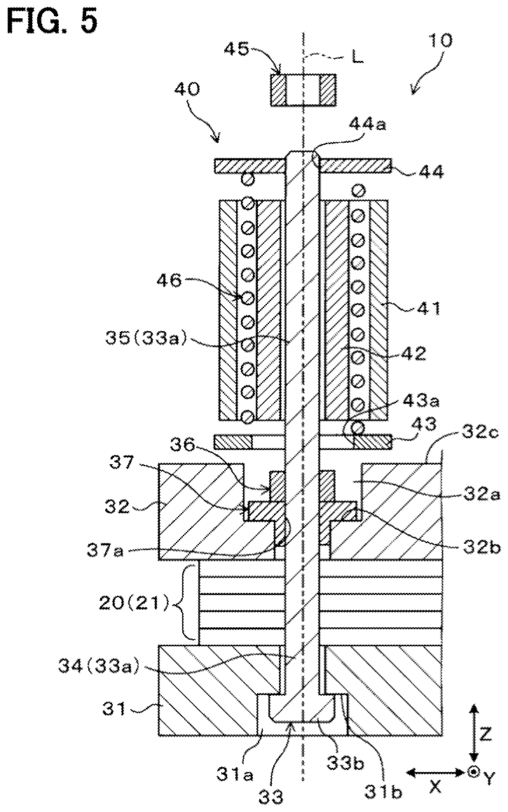

As shown in FIG. 5, when assembling components of the fuel cell structure 10, as the first step, the fastening mechanism 30 is assembled before the load receiving mechanism 40 is assembled. In this first step, the shaft portion 33a of the bolt member 33 is sequentially inserted into the through hole 31a of the bottom plate 31 and the through hole 32a of the upper plate 32, in a state where the cell stack 20 is interposed between the bottom plate 31 and the upper plate 32. After that, the nut member 36 is threaded with the first shaft portion 34 of the bolt member 33 and tightened. As a result, the cell stack 20 is compressed from both sides in the third direction Z by being sandwiched between the bottom plate and the upper plate 32.

In the second step, following the first step, the load receiving mechanism 40 is assembled. In the second step, first, the washer 43, the inner collar 42, the spring member 46, the outer collar 41, and the holding plate 44 are arranged on the axis L of the shaft portion 33a of the bolt member 33. After that, the nut member 45 is threaded with the second shaft portion 35 of the bolt member 33 and tightened. As a result, the spring member 46 is compressed in the contracting direction, and the spring length in the third direction Z becomes smaller than the natural length. Then, the elastic urging force of the spring member 46 at this time is applied to the upper plate 32 and the upper surface 32c.

By executing the second step after the first step, it is possible to suppress an excessive force from being applied to the spring member 46, since the load receiving mechanism 40 is assembled after assembling the fastening mechanism 30.

In the load receiving mechanism 40, it is preferable that at least one of the outer collar 41 and the inner collar 42 is configured as an auxiliary member for setting the spring length in the third direction Z when the spring member 46 is assembled. In this case, the dimension of the auxiliary member in the third direction Z is set according to the desired control length of the spring member 46 in the third direction Z. Therefore, when the nut member 45 is tightened to a predetermined tightening-possible position, the movement of the nut member 45 toward the head portion 33b of the bolt member 33 is blocked by the auxiliary member. Accordingly, the length of the spring member 46 in the third direction Z can be automatically set to the control length by simply tightening the nut member 45, so that the load management of the spring member 46 becomes unnecessary.

Further, the auxiliary member is preferably configured so that the linear expansion coefficient in the third direction Z is lower than that of the bolt member 33, In this case, the auxiliary member is less likely to extend in the third direction Z than the bolt member 33 when the temperature rises. The “linear expansion coefficient” indicates the amount of expansion or contraction per unit length, when the length in the third direction Z changes due to a temperature change, per temperature. Since the bolt member 33 extends in the third direction Z than the auxiliary member when the temperature rises, it is possible to restrict the load loss where the compression load applied to the cell stack 20 by the load receiving mechanism 40 is weakened by the extension of the auxiliary member.

In the fuel cell structure 10, the temperature of the cell stack 20 is raised by energization and used under high temperature conditions, Therefore, if the bolt member 33 is made of a general metal material, the shaft portion 33a of the bolt member 33 tends to extend in the third direction Z, which is the axial direction, when the temperature of the cell stack 20 is raised. At this time, if the degree of expansion and deformation of the shaft portion 33a of the bolt member 33 in the compression release direction Z1 exceeds the degree of expansion and deformation of the cell stack 20 in the compression release direction Z1, a difference in linear expansion is generated between the shaft portion 33a of the bolt member 33 and the cell stack 20. Due to the difference in linear expansion, a phenomenon called “load loss” may occur, in which the load applied to the cell stack 20 in the compression direction at the assembling time decreases.

According to the present embodiment, in order to suppress the load loss that may occur when the temperature rises after the cell stack 20 is assembled in the fuel cell structure 10, the load receiving mechanism 40 is provided separately from the fastening mechanism 30.

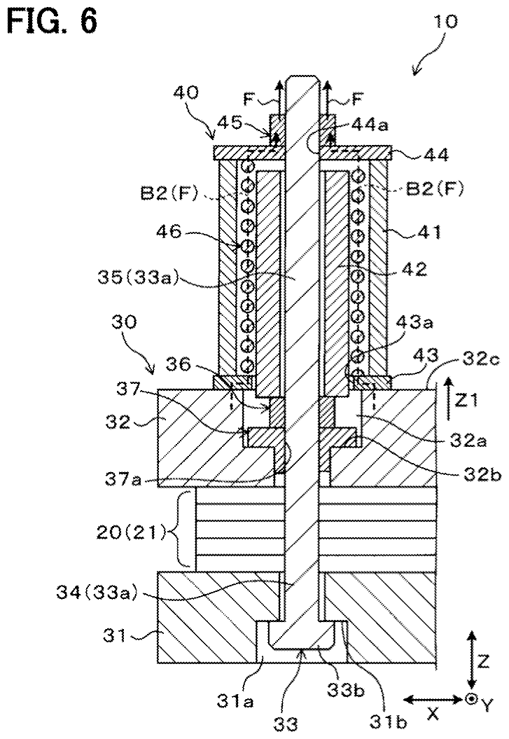

As shown in FIG. 6, when the temperature of the cell stack 20 rises, the shaft portion 33a of the bolt member 33 extends in the compression release direction Z1 with respect to the head portion 33b, and the spring member 46 follows this. Specifically, the spring member 46 is elastically deformed in the extension direction so as to strengthen the pressing against the upper plate 32 that presses the cell stack 20, That is, the spring member 46 extends in the third direction Z by the amount of the linear expansion difference generated between the shaft portion 33a of the bolt member 33 and the cell stack 20.

At this time, the load receiving mechanism 40 is configured to receive only the linear expansion load F, which is an increase in the load in the compression release direction Z1 generated when the temperature of the cell stack 20 rises, independently of the fastening mechanism 30 through the load receiving path B2. Therefore, even when a linear expansion difference occurs between the shaft portion 33a of the bolt member 33 and the cell stack 20 when the temperature of the cell stack 20 is raised, the spring member 46 expands in the third direction Z, such that the linear expansion load F in the compression release direction Z1 can be received by the nut member 45 on the load receiving path B2. Even when the compressive load by the fastening mechanism 30 is reduced due to this linear expansion difference and the load input is weakened, the elastic urging force by the spring member 46 can be applied to the upper plate 32, As a result, the compressed state of the cell stack 20 can be ensured even when the temperature of the cell stack 20 is raised, and the load loss is less likely to be generated.

Next, the operation and effect of the first embodiment will be described.

In the fuel cell structure 10, the cell stack 20 formed by stacking the cells 21 is fastened in a state of being compressed from both sides by the fastening mechanism 30 at the time of assembly. Therefore, in the assembled state of the cell stack 20, the cell stack 20 receives a compressive load from the fastening mechanism 30, while the fastening mechanism 30 receives a load from the cell stack 20 in the compression release direction Z1.

In the present embodiment, the load receiving mechanism 40 is provided separately from the fastening mechanism 30 in order to receive the load in the compression release direction Z1 from the cell stack 20 compressed by the fastening mechanism 30. The load receiving mechanism 40 has a function of receiving the linear expansion load F in the compression release direction Z1 caused by a decrease in the compressive load by the fastening mechanism 30 when the temperature of the cell stack 20 is raised. That is, the load receiving mechanism 40 provided separately from the fastening mechanism 30 for fastening the cell stack 20 in the compressed state is in charge of receiving the linear expansion load F, which is an increase in the load when the temperature of the cell stack 20 is raised.

As a result, the load receiving mechanism 40 can restrict the load loss generated when the temperature of the cell stack 20 is raised, and the cell stack 20 can be maintained in a desired compressed state. Therefore, the current collecting property and the gas sealing property of the cell stack 20 can be suppressed from deteriorating. Further, the load receiving mechanism 40 receives the linear expansion load F generated in the compression release direction Z1 when the temperature of the cell stack 20 rises. Therefore, even if the spring member 46 is used for the load receiving mechanism 40, the load handled by the spring member 46 can be suppressed to a low value as the linear expansion load F which is an increment when the temperature of the cell stack 20 rises. Thus, the spring member 46 can be downsized or reduced in number. As a result, it becomes possible to restrict the fuel cell structure 10 from becoming large.

Therefore, according to the first embodiment, it is possible to provide a downsized fuel cell structure 10 capable of suppressing the load loss when the temperature of the cell stack 20 is raised.

According to the first embodiment, the nut member 36 threaded with the first shaft portion 34 of the bolt member 33 is used to compress the cell stack 20 by utilizing the axial force of the bolt member 33 in the fastening mechanism 30. In the load receiving mechanism 40, the nut member 45 threaded to the second shaft portion 35 of the bolt member 33 can be used to compress the cell stack 20 by utilizing the axial force of the bolt member 33. At this time, both the nut member 36 and the nut member 45 are provided on the bolt member 33 by being threaded with the bolt member 33, and can be easily assembled to the bolt member 33.

According to the first embodiment, the fastening mechanism 30 does not use an elastic element such as a spring member to fasten the cell stack 20 in a compressed state. Since the fastening mechanism 30 substantially includes only the bolt member 33 and the nut member 36, the structure of the fastening mechanism 30 can be simplified.

According to the first embodiment, the second shaft portion 35, which is a part of the bolt member 33 of the fastening mechanism 30 shares the function of the load receiving mechanism 40. Thus, it is effective in reducing the number of parts in each of the fastening mechanism 30 and the load receiving mechanism 40.

Hereinafter, other embodiments related to the first embodiment will be described with reference to the drawings. In other embodiments, the same elements as the elements of the first embodiment are designated by the same reference numerals, and the description of the same elements will be omitted.

### Second Embodiment

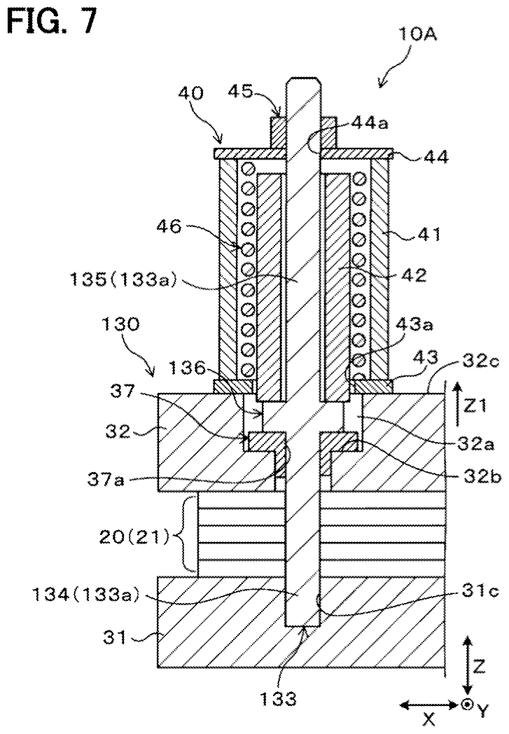

As shown in FIG. 7, a fuel cell structure 10A of a second embodiment has a fastening mechanism 130 different from that of the fastening mechanism 30 of the first embodiment. In the fastening mechanism 130, a shaft member 133 is used instead of the bolt member 33. The fastening mechanism 130 is assembled before assembling the load receiving mechanism 40 as in the case of the fastening mechanism 30.

In the fastening mechanism 130, a shaft portion 133a of the shaft member 133 is a long shaft portion extending in the third direction Z so as to penetrate the through hole 32a of the upper plate 32. The shaft member 133 has a disc-shaped flange portion 136 formed by partially expanding the diameter of the shaft portion 133a. The shaft portion 133a of the shaft member 133 has a first shaft portion 134 and a second shaft portion 135 extending from the flange portion 136 so as to be away from each other in the third direction Z.

The flange portion 136 is used in place of the nut member 36 of the first embodiment, and has the same function as the nut member 36. The flange portion 136 is a diameter-expanded portion in the shaft portion 133a, and is an engaging portion integrally provided on the shaft member 133 in order to compress the cell stack 20 in the third direction Z by utilizing the axial force of the shaft member 133. The flange portion 136 is an engaging portion provided on the shaft member 133 by partially expanding the diameter of the shaft portion 133a of the shaft member 133.

A male thread is formed on the outer periphery of only the extended tip portion (one end portion of the shaft portion 133a) of the first shaft portion 134, while a female thread is formed on the inner peripheral surface of an engaging hole 31c in the bottom plate 31 with which the first shaft portion 134 can be engaged. Further, the second shaft portion 135 is formed with a male thread on the outer periphery of only the extended tip portion (the other end portion of the shaft portion 133a). The second shaft portion 135 is configured to be threaded with the nut member 45, similarly to the second shaft portion 35 of the first embodiment.

The nut member 45 is configured to pressurize the cell stack 20 in cooperation with the shaft member 133 when engaged with the second shaft portion 135. The nut member 45 is an engaging portion provided on the shaft member 133 by threading (engagement) with the shaft member 133.

At the time of assembling the fastening mechanism 133, the first shaft portion 134 of the shaft member 133 is inserted into the through hole 32a of the upper plate 32 to engage with the engaging hole 31c of the bottom plate 31 in a state where the cell stack 20 is sandwiched between the bottom plate 31 and the upper plate 32. As a result, the bottom plate 31 and the upper plate 32 can be compressed so as to approach each other in the third direction Z. At this time, the flange portion 136 applies a downward pressing load to the stepped portion 32b of the upper plate 32 via the collar 37. As a result, a compressive load for compressing the plurality of cells 21 is applied to the cell stack 20.

The other configuration is the same as that of the first embodiment.

According to the fuel cell structure 10A of the second embodiment, by using the shaft member 133 with a flange, instead of the bolt member 33 of the first embodiment, the parts corresponding to the nut member 36 are not required. Therefore, the number of parts can be reduced and the assembly work can be simplified. Further, since the male thread may be threaded only on both ends of e shaft portion 133a the load of the processing work can be suppressed to a small level.

Other than that, the second embodiment has the same effect as that of the first embodiment.

In a modification related to the second embodiment, the first shaft portion 134 of the shaft member 133 is configured as a cylindrical shaft portion having no male thread formed on the outer periphery thereof, and the engaging hole 31c of the bottom plate 31 is formed as a cylindrical shaft portion in which a female thread is not formed on the inner peripheral surface. At this time, it is preferable that the shaft member 133 is fixed to the bottom plate 31 in a state where the first shaft portion 134 is press-fitted into the engaging hole 31c of the bottom plate 31, or the first shaft portion 134 is inserted into and welded with the engaging hole 31c of the bottom plate 31, As a result, the threading process in the second embodiment can be omitted.

Further, in another modification related to the second embodiment, the extended tip portion of the second shaft portion 135 of the shaft member 133 may have a portion such as a flange portion 136, instead of the nut member 45. As a result, the parts corresponding to the nut member 45 of the second embodiment can be omitted. Thus, the number of parts can be reduced, and the assembly work can be simplified.

### Third Embodiment

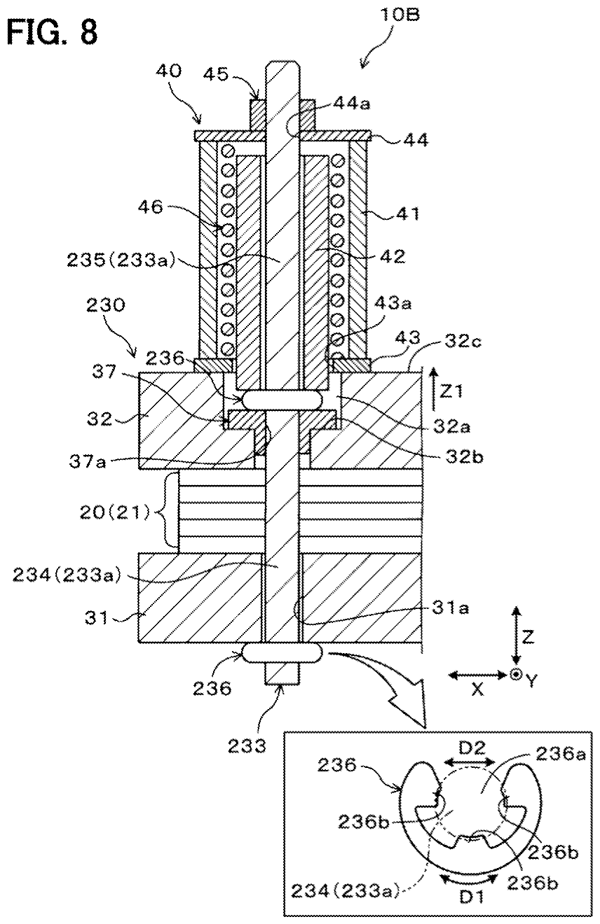

As shown in FIG. 8, a fuel cell structure 10B of a third embodiment has a fastening mechanism 230 different from that of the fastening mechanism 30 of the first embodiment. In the fastening mechanism 230, a shaft member 233 is used instead of the bolt member 33, and a locking pin 236 is used instead of the nut member 36. The fastening mechanism 230 is assembled before the load receiving mechanism 40 is assembled, as in the case of the fastening mechanism 30.

The shaft portion 233a of the shaft member 233 is a long shaft portion extending in the third direction Z so as to penetrate both the through hole 31a of the bottom plate 31 and the through hole 32a of the upper plate 32. The shaft portion 133a has a first shaft portion 234 in which a male thread is not formed on the outer periphery, and a second shaft portion 235 in which a male thread is formed on the outer periphery. The first shaft portion 234 is configured so that the locking pin 236 can be attached to the outer periphery of the first shaft portion 234.

The locking pin 236 has the same function as the nut member 36 of the first embodiment. The locking pin 236 is a flat plate-shaped member having an opening 236a capable of receiving the first shaft portion 234 of the shaft member 233, and plural lock pieces 236b arranged in the circumferential direction D1 so as to surround the opening 236a and elastically deformable in the radial direction D2. The locking pin 236 is configured such that the opening diameter of the opening 236a is slightly smaller than the shaft diameter of the first shaft portion 234. The locking pin 236 is locked to the outer periphery of the first shaft portion 234 by inserting the first shaft portion 234 of the shaft member 233 into the opening 236a.

The locking pin 236 is an engaging portion provided on the shaft member 233 order to compress the cell stack 20 in the third direction Z by utilizing the axial force of the shaft member 233. By attaching the locking pin 236 to the first shaft portion 234, the relative movement of the first shaft portion 234 and the locking pin 236 in the third direction Z is restricted. Further, the locking pin 236 attached to the first shaft portion 234 is removed from the first shaft portion 234 by being pulled out against the elastic urging force. Here, the locking pin 236 is an engaging portion provided on the shaft member 233 by being attached to the shaft member 233.

At the time of assembling the fastening mechanism 230, the locking pin 236 is attached to the tip end portion of the first shaft portion 234 of the shaft member 233 in a state where the cell stack 20 is sandwiched between the bottom plate 31 and the upper plate 32, and the first shaft portion 234 is sequentially inserted into the through hole 31a of the bottom plate 31 and the through hole 32a of the upper plate 32, After that, another locking pin 236 is attached to the outer periphery of the first shaft portion 234 so as to apply a downward pressing load to the stepped portion 32b of the upper plate 32 via the collar 37, whereby the bottom plate 31 and the upper plate 32 can be compressed so as to approach each other in the third direction Z. As a result, a compressive load for compressing the plurality of cells 21 is applied to the cell stack 20.

The nut member 45 pressurizes the cell stack 20 in cooperation with the shaft member 233 when threaded with the second shaft portion 235 of the shaft member 233. The nut member 45 is an engaging portion provided on the shaft member 233 by threading (engagement) with the shaft member 233.

The other configuration is the same as that of the first embodiment.

According to the fuel cell structure 10B of the third embodiment, the assembling operation of the fastening mechanism 230 can be performed by a simple operation of inserting the first shaft portion 234 of the shaft member 233 into the opening 236a of the locking pin 236.

Other than that, the third embodiment has the same effect as that of the first embodiment.

In a modification related to the third embodiment, an engaging member such as a locking pin 236 is attached to the extended tip portion of the second shaft portion 235 of the shaft member 233 instead of the nut member 45. This makes it possible to perform the assembly operation of the load receiving mechanism 40 by a simple operation using the locking pin 236.

### Fourth Embodiment

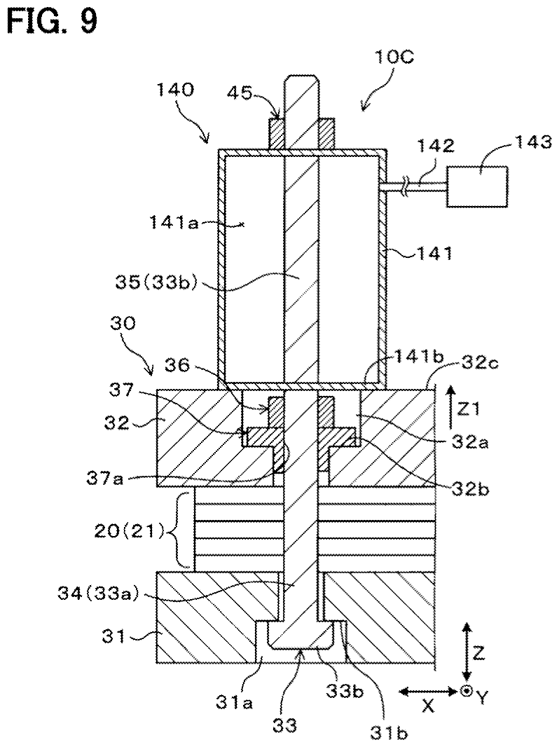

As shown in FIG. 9, a fuel cell structure 10C of a fourth embodiment has a load receiving mechanism 140 different from that of the load receiving mechanism 40 of the first embodiment. The load receiving mechanism 140 is assembled after the fastening mechanism 30 is assembled, as in the case of the load receiving mechanism 40.

The load receiving mechanism 140 includes a cylindrical pneumatic cylinder 141 and an air supply pump 143 connected so as to supply air to the internal space 141a of the pneumatic cylinder 141 through a connecting pipe 142.

The pneumatic cylinder 141 is an elastic element that is elastically deformably interposed between the cell stack 20 and the nut member 45 in the third direction Z. The pneumatic cylinder 141 has at least a bottom surface portion 141b elastically deformable in the third direction Z in order to pressurize the cell stack 20. In the pneumatic cylinder 141, the bottom surface portion 141b abuts on the upper surface 32c of the upper plate 32 by threading the nut member 45 into the second shaft portion 35 of the bolt member 33 penetrating the pneumatic cylinder 141 in the third direction Z. The air supply pump 143 is a pressure medium supply unit that supplies air, which is a pressure medium, to the internal space 141a of the pneumatic cylinder 141. The load receiving mechanism 140 is configured to apply a compressive load to the cell stack 20 by supplying air from the air supply pump 143 to the internal space 141a.

In the load receiving mechanism 140, instead of the spring member 46 of the first embodiment, a spring structure using air supplied from the air supply pump 143, a so-called “air spring”, is used. Under the control of the air supply pump 143, the bottom surface portion 141b of the pneumatic cylinder 141 is elastically deformed downward. As a result, the load receiving mechanism 140 can apply a compressive load to the upper plate 32 so that the load loss is not generated when the temperature of the cell stack 20 is raised. Further, the load receiving mechanism 140 can receive the linear expansion load F in the compression release direction Z1 generated when the temperature of the cell stack 20 rises, due to the pneumatic cylinder 141, similarly to the load receiving mechanism 40 of the first embodiment.

The other configuration is the same as that of the first embodiment.

According to the fuel cell structure 10C of the fourth embodiment, the compressive load applied to the upper plate 32 in the load receiving mechanism 140 can be adjusted by air pressure control by the air supply pump 143.

In a modification related to the fourth embodiment, instead of using the pneumatic pressure generated by the air supplied to the pneumatic cylinder 141, a compressive load can be applied to the cell stack 20 using a hydraulic pressure generated by the supply of a certain hydraulic oil (pressure medium) to a hydraulic cylinder.

Other than that, the fourth embodiment has the same effect as that of the first embodiment.

### Fifth Embodiment

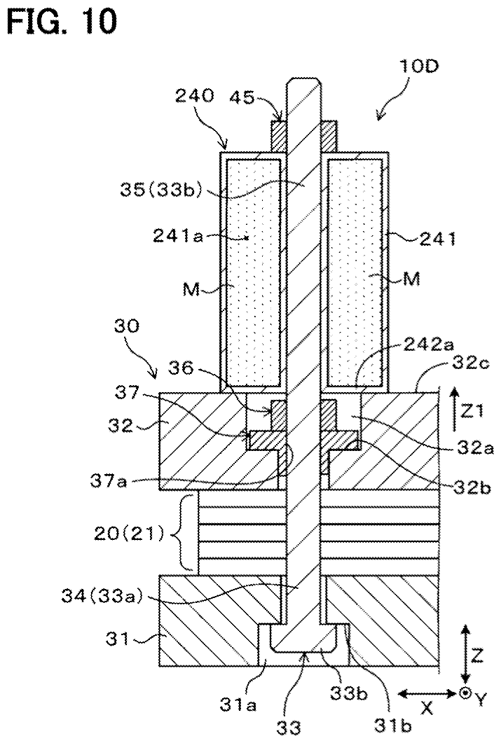

As shown in FIG. 10, a fuel cell structure 10D of a fifth embodiment has a load receiving mechanism 240 different from that of the load receiving mechanism 40 of the first embodiment. The load receiving mechanism 240 is assembled after the fastening mechanism 30 is assembled, as in the case of the load receiving mechanism 40.

The load receiving mechanism 240 includes a storage container 241 having a storage space 241a, and a thermal expansion substance M is stored in the storage space 241a having an annular cross section. The thermal expansion substance M has a volume change with a temperature change within an arbitrary temperature range. The thermal expansion substance M is not particularly limited, but it is typically preferable to use a substance having a property of increasing the volume by changing the phase from liquid to gas due to heat reception.

The storage container 241 is an elastic element that is elastically deformably interposed between the cell stack 20 and the nut member 45 in the third direction Z, The storage container 241 is configured as an elastic container in which at least the bottom surface portion 241b can be elastically deformed in the third direction Z. The storage container 241 has the bottom surface portion 241b that abuts the upper surface 32c of the upper plate 32 by threading the nut member 45 into the second shaft portion 35 of the bolt member 33 that penetrates the storage container 241 in the third direction Z.

According to the load receiving mechanism 240, by adjusting the temperature of the storage container 241 within a temperature range in which the volume expansion of the heat expansion substance M occurs, the heat expansion substance M in the storage space 241a expands in volume due to heat reception. The bottom surface portion 241b of the storage container 241 is elastically deformed downward. At this time, the load receiving mechanism 240 can apply a compressive load from the bottom surface portion 241b of the storage container 241 to the upper plate 32 so that the load loss is not generated when the temperature of the cell stack 20 is raised. Further, the storage container 241 of the load receiving mechanism 240 can receive the linear expansion load F generated in the compression release direction Z1 when the temperature of the cell stack 20 is raised.

The other configuration is the same as that of the first embodiment.

According to the fuel cell structure 10D of the fifth embodiment, it is possible to apply a compressive load to the upper plate 32 by utilizing the volume expansion of the thermal expansion substance M due to the temperature rise of the cell stack 20 in the load receiving mechanism 240.

Other than that, the fifth embodiment has the same effect as that of the first embodiment.

### Sixth Embodiment

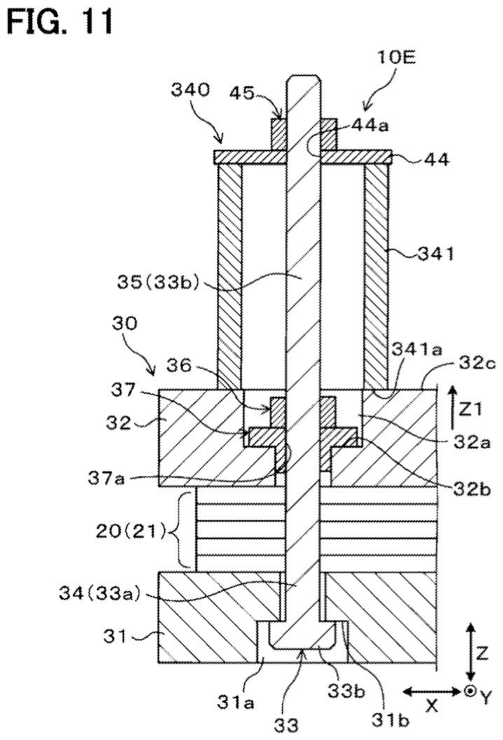

As shown in FIG. 11, a fuel cell structure 10E of a sixth embodiment has a load receiving mechanism 340 different from that of the load receiving mechanism 40 of the first embodiment. The load receiving mechanism 340 is assembled after the fastening mechanism 30 is assembled, as in the case of the load receiving mechanism 40.

The load receiving mechanism 340 includes a cylindrical metal member 341, and the metal member 341 is made of a shape memory alloy that can be elastically deformed in the third direction Z by a temperature change. The shape memory alloy has a property of shrinking in the third direction Z in an attempt to return to their original shape by heating.

The bottom portion 341a of the metal member 341 abuts on the upper surface 32c of the upper plate 32 by threading the nut member 45 into the second shaft portion 35 of the bolt member 33 penetrating the metal member 341 in the third direction Z. The metal member 341 is an elastic element that is elastically deformably interposed between the cell stack 20 and the nut member 45 in the third direction Z.

According to the load receiving mechanism 340, the metal member 341 is elastically deformed so as to contract in the third direction Z due to heating. At this time, the load receiving mechanism 340 can apply a compressive load from the bottom portion 341a of the metal member 341 to the upper plate 32 so that the load loss is not generated when the temperature of the cell stack 20 is raised. Further, the metal member 341 of the load receiving mechanism 340 can receive the linear expansion load F generated in the compression release direction Z1 when the temperature of the cell stack 20 is raised.

The other configuration is the same as that of the first embodiment.

According to the fuel cell structure 10E of the sixth embodiment, it is possible to apply a compressive load to the upper plate 32 by utilizing the elastic deformation of the metal member 341 in the third direction Z in the load receiving mechanism 340.

Other than that, the sixth embodiment has the same effect as that of the first embodiment.

### Seventh Embodiment

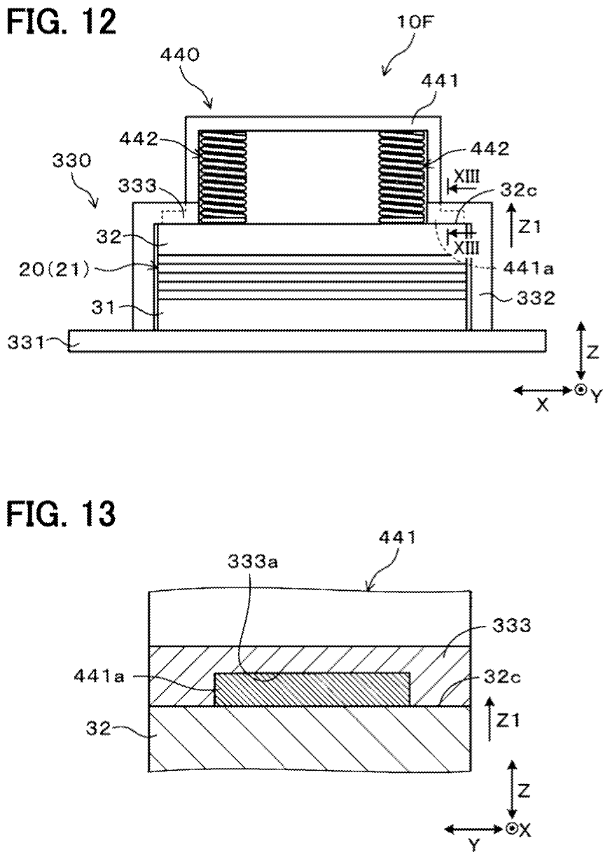

As shown in FIG. 12, a fuel cell structure 10F of a seventh embodiment has a fastening mechanism 330 different from that of the fastening mechanism 30 of the first embodiment, and a load receiving mechanism 440 different from that of the load receiving mechanism 40 of the first embodiment. The fastening mechanism 330 and the load receiving mechanism 440 are assembled at the same time.

The fastening mechanism 330 fastens the cell stack 20 in a compressed state from both sides in the third direction Z, similarly to the fastening mechanism 30. The fastening mechanism 330 includes a base member 331 that supports the bottom plate 31 from the lower side, and a clamp member 332. The clamp member 332 has a pressurizing portion 333 for sandwiching the cell stack 20 with the base member 331, The clamp member 332 is assembled in a state where a bottom plate portion 441a of a pressing member 441 is fitted in a recess 333a of the pressurizing portion 333 (see FIG. 13). Therefore, the pressing member 441 is assembled at the same time as the clamp member 232 in a state where the bottom plate portion 441a is pressed from the upper side by the recess 333a of the pressurizing portion 333.

The clamp member 332 includes a so-called “lever” or “cam” clamp structure, and a distance between the pressurizing portion 333 and the base member 331 in the third direction Z is made variable by interlocking with the operation of a peripheral operation member (not shown). Accordingly, it is possible to switch between a clamp operation for clamping the cell stack 20 and a clamp release operation for releasing the clamping of the cell stack 20 with the movement of the pressurizing portion 333 of the clamp member 332 in the third direction Z.

When assembled to the clamp member 332, the fastening force of the clamp member 332 is input to the cell stack 20 via the pressurizing portion 333. As a result, the cell stack 20 is given a compressive load that compresses the cells 21 from both sides in the third direction Z. At this time, the pressurizing portion 333 of the clamp member 332 applies a load in the compression direction to the cell stack 20, while receiving a load from the cell stack 20 in the compression release direction Z1 which is opposite to the compression direction.

The load receiving mechanism 440 receives the linear expansion load F in the compression release direction Z1 caused by a decrease in compressive load by the fastening mechanism 330 when the temperature of the cell stack 20 is raised. The load receiving mechanism 440 includes the pressing member 441 and plural spring members 442. Each of the spring members 442 is interposed between the pressing member 441 and the upper plate 32, and is pressed by the pressing member 441. Therefore, by assembling the pressing member 441, the elastic urging force of each spring member 442 is applied as a pressing force to the upper surface 32c of the upper plate 32 via the bottom plate portion 441a.

When the clamp member 332 expands in the compression release direction Z1 due to the linear expansion difference from the cell stack 20 when the temperature of the cell stack 20 rises, the spring member 442 elastically deforms in the expansion direction following this. That is, the spring member 442 extends in the third direction Z by the amount of the linear expansion difference generated between the clamp member 332 and the cell stack 20. As a result, the compressed state of the cell stack 20 can be ensured even when the temperature of the cell stack 20 is raised, and the load loss is less likely to be generated.

The other configuration is the same as that of the first embodiment.

According to the fuel cell structure 10F of the seventh embodiment, the pressing member 441 of the load receiving mechanism 440 can receive the linear expansion load generated in the compression release direction Z1 due to the temperature rise of the cell stack 20. Further, as compared with the first embodiment, the configurations of the fastening mechanism 330 and the load receiving mechanism 440 can be simplified.

Other than that, the seventh embodiment has the same effect as that of the first embodiment.

The present disclosure is not limited to the embodiments, and various applications and modifications can be considered.

The embodiments can also be applied to a fuel cell such as molten carbonate fuel cell (MCFC) having a relatively high operating temperature, other than the solid oxide fuel cell having the cell stack 20.

What is claimed is:

1. A fuel cell structure comprising:
a cell stack in which a plurality of cells is stacked;
a fastening mechanism configured to fasten the cell stack in a compressed state from both sides in a stacking direction of the plurality of cells; and
a load receiving mechanism configured to receive a load from the cell stack in a compression release direction, wherein
the load receiving mechanism is configured to receive a linear expansion load in the compression release direction, the linear expansion load being caused by a decrease in compressive load by the fastening mechanism when a temperature of the cell stack is raised.

2. The fuel cell structure according to claim 1, wherein
the fastening mechanism has
a shaft member extending in the stacking direction of the plurality of cells, and
an engaging portion provided on the shaft member to compress the cell stack by utilizing an axial force of the shaft member.

3. The fuel cell structure according to claim 2, wherein
the load receiving mechanism has
a second engaging portion provided on the shaft member separately from the engaging portion of the fastening mechanism, and
an elastic element elastically deformably interposed between the cell stack and the second engaging portion in the stacking direction, and
the load receiving mechanism is configured to apply a compressive load to the cell stack by utilizing an elastic force of the elastic element.

4. The fuel cell structure according to claim 3, wherein the elastic element comprises a compression coil spring,
the load receiving mechanism has an auxiliary member configured to set a spring length of the compression coil spring in the stacking direction, when the compression coil spring is assembled.

5. The fuel cell structure according to claim 4, wherein the auxiliary member is configured to have a linear expansion coefficient in the stacking direction, which is lower than that of the shaft member.

6. The fuel cell structure according to claim 2, wherein
the shaft member is a bolt member, and
the engaging portion is a nut member threaded with the bolt member.

7. The fuel cell structure according to claim 2, wherein
the shaft member has a shaft portion and a diameter-expanded portion formed by partially expanding a circumference of the shaft portion in a radial direction, and the engaging portion is the diameter-expanded portion of the shaft member.

8. The fuel cell structure according to claim 2, wherein
the engaging portion comprises a locking pin,
the locking pin has an opening and a plurality of locking pieces arranged in a circumferential direction so as to surround the opening and elastically deformable in a radial direction, and
the locking pin is engaged with an outer periphery of a shaft portion of the shaft member when the shaft portion is inserted into the opening.

9. The fuel cell structure according to claim 3, wherein
the load receiving mechanism includes
a cylinder provided as the elastic element so as to be elastically deformable in the stacking direction, and
a pressure medium supply unit ha supplies a pressure medium to an internal space of the cylinder, and
the load receiving mechanism is configured to apply a compressive load to the cell stack by utilizing an elastic deformation of the cylinder in the stacking direction when the so pressure medium is supplied from the pressure medium supply unit to the internal space.

10. The fuel cell structure according to claim 3, wherein
the load receiving mechanism includes a storage container provided as the elastic element so as to be elastically deformable in the stacking direction,
a storage space of the storage container houses a heat expansion substance that changes in volume when a temperature changes, and
the load receiving mechanism is configured to apply a compressive load to the cell stack by utilizing an elastic deformation of the storage container in the stacking direction when a temperature of the storage container is adjusted within a temperature range in which the heat expansion substance expands in volume.

11. The fuel cell structure according to claim 3, wherein
the load receiving mechanism includes a metal member made of a shape memory alloy provided as the elastic element so as to be elastically deformable in the stacking direction when a temperature changes, and
the load receiving mechanism is configured to apply a compressive load to the cell stack by utilizing an elastic deformation of the metal member in the stacking direction.

12. The fuel cell structure according to claim 1, wherein the load receiving mechanism is assembled after the cell stack is fastened by the fastening mechanism.
